(19) United States
(12) Patent Application Publication
(10) Pub. No.: US 2010/0156853 A1
(43) Pub. Date: Jun. 24, 2010

(54) DISPLAY APPARATUS AND PROGRAM

(75) Inventor: Atsushi NARUSAWA, Hino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/627,516

(22) Filed: Nov. 30, 2009

(30) Foreign Application Priority Data
Dec. 18, 2008 (JP) 2008-322465

(51) Int. Cl. G09G 3/22

(52) U.S. Cl. 345/183

(57) ABSTRACT

A display apparatus includes: a display surface that includes a plurality of pixels; a detection section that detects positions of the plurality of pixels successively designated on the display surface for each predetermined cycle; a rewriting section that rewrites colors of the pixels corresponding to the trace sequentially linking the positions detected by the detection section; a direction specifying section that, when the detection section detects the positions, specifies a direction of the trace at the corresponding positions; and a cycle changing section that, when the direction of the trace specified by the direction specifying section is changed and a magnitude of change of the corresponding direction increases, shortens the cycle in which the detection section detects the positions.

### BACKGROUND

1. Technical Field

The present invention relates to a technique of suppressing consumption of electric power required for image display.

2. Related Art

In portable display apparatuses having an electrophoresis display body called an electronic paper, mobile display apparatuses such as a PDA (Personal Digital Assistant), and the like, there is a known apparatus that displays an image indicating positions, which is designated by a pen tip, when a user makes a tracing on the display surface with a pen. In such a pen drawing, it is preferable to display an image accurately representing the positions designated by the pen. In JP-A-5-324179, when the positions of a trace designated by the pen is sampled in a predetermined cycle, a technique of changing the sampling cycle in accordance with a writing speed is disclosed.

However, in portable and mobile display apparatuses, it is preferable to reduce power consumption as much as possible.

### SUMMARY

An advantage of some aspects of the invention is to display accurately an image representing positions designated on the display surface.

In order to achieve the advantage, according to a first aspect of the invention, provided is a display apparatus including: a display surface that includes a plurality of pixels; a detection section that detects the positions of the plurality of pixels successively designated on the display surface for each predetermined cycle; a rewriting section that rewrites colors of the pixels corresponding to the trace sequentially linking the positions detected by the detection section; a direction specifying section that, when the detection section detects the positions, specifies the direction of the trace at the corresponding positions; and a cycle changing section that, when the direction of the trace specified by the direction specifying section is changed and the magnitude of change of the corresponding direction increases, shortens the cycle in which the detection section detects the positions. With such a configuration, it is possible to display accurately the image representing the positions designated on the display surface.

Further, according to a second aspect of the invention, provided is a display apparatus including: a display surface that includes a plurality of pixels; a detection section that detects the positions of the plurality of pixels successively designated on the display surface for each predetermined cycle; a rewriting section that rewrites colors of the pixels corresponding to the trace sequentially linking the positions detected by the detection section; a direction specifying section that, when the detection section detects the positions, specifies the direction of the trace at the corresponding positions; and a cycle changing section that, when the direction of the trace specified by the direction specifying section is changed and the magnitude of change of the corresponding direction decreases, elongates the cycle in which the detection section detects the positions. With such a configuration, it is possible to display accurately the image representing the positions designated on the display surface.

In the aspects of the invention, it is preferable that the direction specifying section should sequentially specify a direction of a segment linking two positions, which are successively detected by the detection section, as the direction of the trace. In addition, it is also preferable that the magnitude of the change of direction be an angle formed by the two segments sequentially specified as the direction of the trace by the direction specifying section. With such a configuration, it is possible to simplify a configuration for specifying the direction of the trace.

In the aspects of the invention, it is preferable that the display apparatus should include a rate specifying section that specifies a value as a rate at the time of successively designating the positions of the plurality of pixels, the value being obtained by dividing the distance between the two positions, which are successively detected by the detection section, by the predetermined cycle. In addition, it is also preferable that the cycle changing section should include a correction section that corrects the cycle, which changes in accordance with the magnitude of the change, on the basis of the rate specified by the rate specifying section. With such a configuration, it is possible to more accurately display the image representing the positions of the designated pixels.

Further, according to a third aspect of the invention, provided is a program for causing a computer, which controls a display apparatus having a display surface formed of a plurality of pixels, to function as: a detection section that detects the positions of the plurality of pixels successively designated on the display surface for each predetermined cycle; a rewriting section that rewrites colors of the pixels corresponding to the trace sequentially linking the positions detected by the detection section; a direction specifying section that, when the detection section detects the positions, specifies the direction of the trace at the corresponding positions; and a cycle changing section that, when the direction of the trace specified by the direction specifying section is changed and the magnitude of change of the corresponding direction increases, shortens the cycle in which the detection section detects the positions. With such a configuration, it is possible to display accurately the image representing the positions designated on the display surface.

Further, according to a fourth aspect of the invention, provided is a program for causing a computer, which controls a display apparatus having a display surface formed of a plurality of pixels, to function as: a detection section that detects the positions of the plurality of pixels successively designated on the display surface for each predetermined cycle; a rewriting section that rewrites colors of the pixels corresponding to the trace sequentially linking the positions detected by the detection section; a direction specifying section that, when the detection section detects the positions, specifies the direction of the trace at the corresponding positions; and a cycle changing section that, when the direction of the trace specified by the direction specifying section is changed and the magnitude of change of the corresponding direction decreases, elongates the cycle in which the detection section detects the positions. With such a configuration, it is possible to display accurately the image representing the positions designated on the display surface.

### BRIEF DESCRIPTION OF THE DRAWINGS

The invention will be described with reference to the accompanying drawings, wherein like numbers reference like elements.

FIG. 1 is an exterior view illustrating a display apparatus.

FIG. 2 is a block diagram illustrating a configuration of the display apparatus.

FIG. 3 is a diagram illustrating an exemplary case where a user makes a drawing on display surface by using a stylus pen.

FIGS. 4A, 4B, and 4C are diagrams illustrating a procedure of displaying an image on the display surface on the basis of the positions detected on the touch panel by the control section.

FIG. 5 is a diagram illustrating an example of a sampling rate control table.

FIG. 6 is a diagram illustrating an “angle θ”.

FIGS. 7A and 7B are diagrams illustrating a relationship between positions on the touch panel and positions of an image representing a trace which is displayed on the display surface.

FIGS. 8A and 8B are diagrams illustrating a relationship between positions on the touch panel and positions of the image representing the trace which is displayed on the display surface.

FIG. 9 is a flowchart illustrating an operation procedure of a control relating to a change of a sampling rate executed by the control section.

FIG. 10 is a diagram illustrating a positional relationship between positions designated on the touch panel and the image representing the trace which is displayed on the display surface.

### DESCRIPTION OF EXEMPLARY EMBODIMENT

Hereinafter, a preferred embodiment of the invention will be described with reference to the accompanying drawings.

### A. Configuration

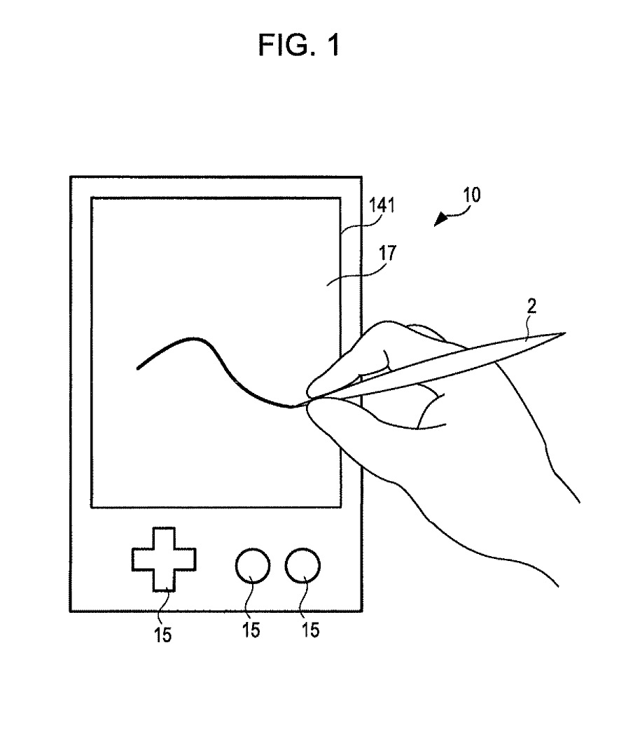

FIG. 1 is an exterior view illustrating the display apparatus 10. The display apparatus 10 is a portable display apparatus which is called an electronic paper and the like.

As shown in FIG. 1, on the front side of the display apparatus 10, an operation section 15, a display surface 141, and a touch panel 17 are provided. The display surface 141 has a plurality of pixels, and the pixels are arranged to thereby form a rectangular region. The touch panel 17 is a substantially transparent member formed in a screen shape, and is disposed on the front side of the display surface 141 on which an image is displayed. A user can see display contents of the display surface 141 disposed on the back side of the touch panel 17 without disturbance of the touch panel 17. When a user moves a pen tip of a stylus pen 2 along the surface of the touch panel 17, the image representing a position designated by the pen tip is displayed on the display surface 141.

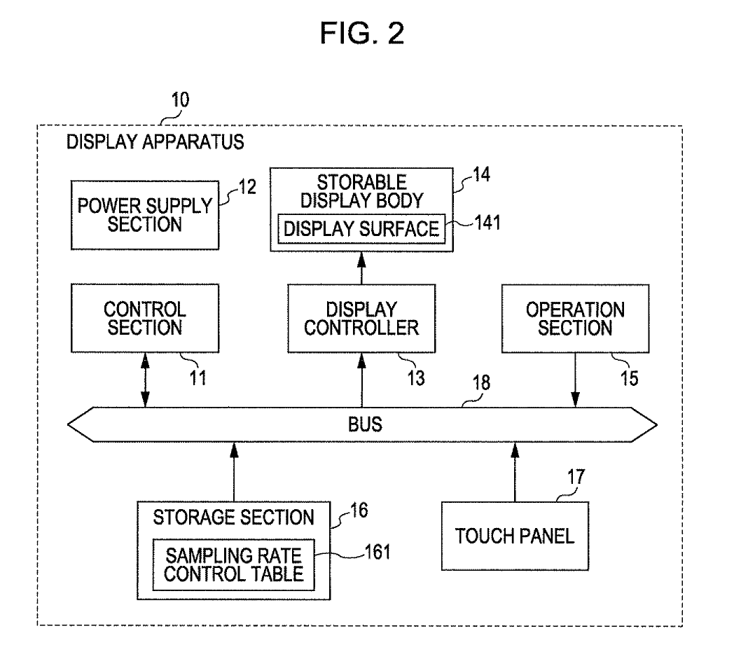

FIG. 2 is a block diagram illustrating a configuration of the display apparatus 10. As shown in the drawing, components provided in the display apparatus 10 are interconnected via a bus 18.

A control section 11 has a CPU (a Central Processing Unit), a memory, a timer, and the like, and controls the respective sections of the display apparatus 10 by allowing the CPU to execute a program stored in the memory. The timer provided in the control section 11 has an oscillating circuit including a crystal oscillator, and measures a time on the basis of the transmission signal output from the oscillating circuit. The power supply section 12 has a rechargeable secondary battery such as Ni—Cd based battery or lithium-ion based battery. The direct current voltage of the secondary battery is supplied as the electric power required for operating the display apparatus 10 to the respective sections of the display apparatus 10 through a power line which is not shown in the drawing. A display controller 13 is a driving circuit that drives the storable display body 14. The display controller 13 supplies a driving signal according to the image to be displayed to the storable display body 14 on the basis of image information stored in a storage section 16. The storable display body 14 is a display body having a liquid crystal layer using storable liquid crystal. The storable display body 14 has a display surface 141 formed of, for example, the plurality of pixels arranged in a shape having 768 columns in a horizontal direction and 1024 rows in a vertical direction, and displays an image with colors of the pixels of the display surface 141 rewritten. Furthermore, a storable liquid crystal is defined as a liquid crystal capable of maintaining a display state (that is, gradation) even when a voltage is not applied, and is, for example, a cholesteric liquid crystal.

An operation section 15 has an arrow button, a switch, and the like. The operation section 15 accepts an operation of a user, and supplies an operation signal to the control section 11 in accordance with operation contents thereof. The storage section 16 is a nonvolatile storage section such as an EEPROM (Electrically Erasable and Programmable Read Only Memory) or a flash memory, and stores various data such as a sampling rate control table 161 and the image data to be displayed. A configuration of the sampling rate control table 161 will be described in detail later.

The touch panel 17 is provided on the front side of the storable display body 14 in view from a user, and has a rectangular region having the same size as the display surface 141. The touch panel 17 senses contact of an object such as a pen tip of the stylus pen 2 for each predetermined microscopic region. Each microscopic region corresponds to a predetermined number of plural pixels (for example, 1×1 pixel or 3×3 pixels) of the display surface 141. The touch panel 17 outputs a detection signal representing the contact of the object for each microscopic region, and supplies the signal to the control section 11. To the respective microscopic regions, coordinates representing respective positions thereof are assigned on the basis of an orthogonal coordinate system in which a position corresponding to the upper left corner point of the display surface 141 is set as the origin and which is based on a vertical side passing the origin and a horizontal side orthogonal to the vertical side, In the touch panel 17, the respective coordinates are previously stored in the memory of the control section 11. Furthermore, in the touch panel, there are various known types such as an electrostatic capacity type and an electromagnetic induction type, a resistive film type, and any type may be used in the touch panel 17.

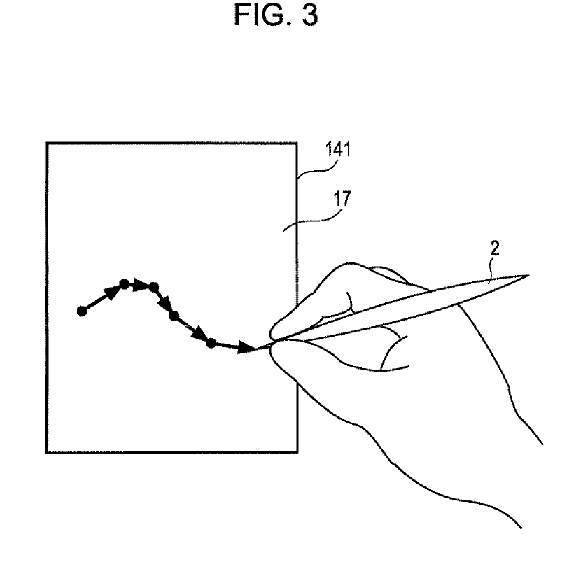

FIG. 3 is a diagram illustrating an exemplary case where a user makes a drawing on display surface 141 of the display apparatus 10 by using the stylus pen 2.

As shown in FIG. 3, a user moves the pen tip of the stylus pen 2 along the surface of the touch panel 17 disposed on the front side of the display surface 141, thereby successively designating positions on the display surface 141. While the designation is performed, the control section 11 detects the designated positions for each predetermined cycle on the basis of the time measured by the timer. This cycle is, for example, 0.01 seconds. That is, the control section 11 and the touch panel 17 are examples of the detection section that detects the positions successively designated on the display surface 141 for each predetermined cycle. Then, the control section 11 acquires coordinates corresponding to the positions detected on the touch panel 17 from the memory, and rewrites the colors of the pixels of the display surface 141 corresponding to the trace that the positions are sequentially linked. That is, the control section 11 is an example of a rewriting section. In such a manner, the control section 11 displays the image of the trace, which indicates the positions designated by a user, on the display surface 141.

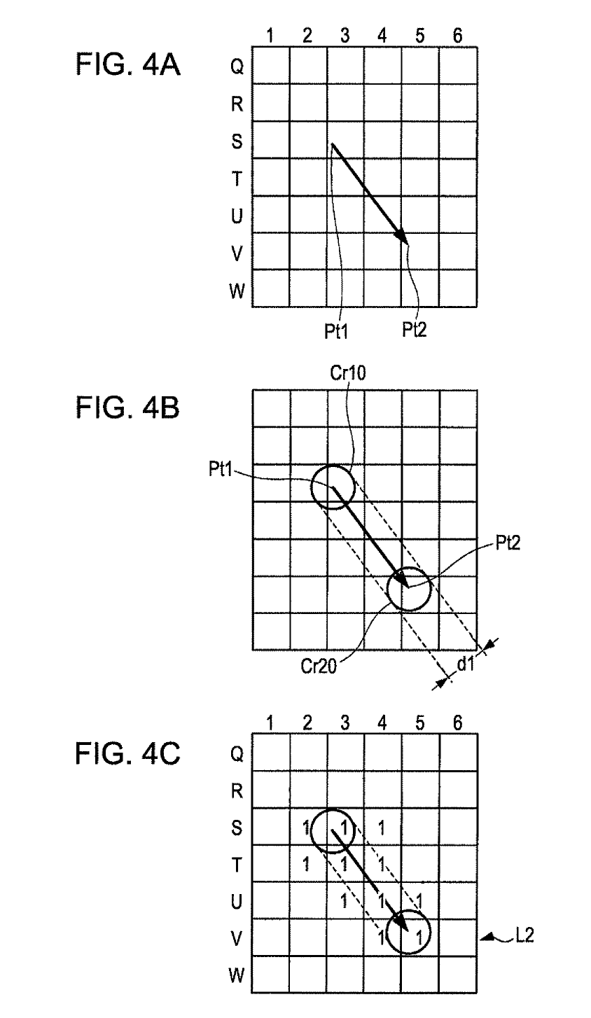

FIGS. 4A, 4B, and 4C are diagrams illustrating a procedure of displaying an image on the display surface 141 on the basis of the positions detected on the touch panel 17 by the control section 11. FIG. 4A shows a part of a pixel group constituting the display surface 141. In the group of pixels of 7×6 which constitute a part of the display surface 141 and are arranged in a lattice shape, here, the columns are expressed as columns 1 to 6, the rows are expressed as rows Q to W, and the pixel located on the row Q and the column 1 is expressed as a “pixel Q1”, for convenience of description. As shown in FIG. 4A, a user puts the pen tip of the stylus pen 2 on a point of the touch panel 17 corresponding to the point Pt1 within the pixel S3. Then, referring to a line width d1 previously stored in the storage section 16, the control section 11 calculates the circle Cr10, which is centered on the point Pt1 and has a diameter equal to the line width d1, as shown in FIG. 4B. In addition, the control section 11 rewrites pixel values of the pixels, which are located on positions overlapped with the circle Cr10, from “0” into “1”. At this time, the pixel of which a pixel value is rewritten into “1” is a pixel corresponding to the position designated by the pen tip.

Next, it is assumed that a user moves the pen tip of the stylus pen 2 from the point Pt1 toward the point Pt2 on the touch panel 17 corresponding to the point Pt2 within the pixel VS, and the control section 11 detects the position at the point Pt2. In this case, the control section 11 rewrites the pixel in the same manner as the point Pt1. That is, the control section 11 calculates the circle Cr20 which is centered on the point Pt2 and has a diameter equal to the line width d1, and rewrites pixel values of the pixels, which are located on the positions overlapped with the circle Cr20, from “0” into “1”. The control section 11 thereafter rewrites pixel values of the pixels, which are located on the positions overlapped with a region directly linking the circle Cr10 to the circle Cr20, from “0” into “1”.

Undergoing such a process, as shown in FIG. 4C, colors of the respective pixels are rewritten in accordance with the designation positions. Furthermore, in FIG. 4C, the signs “0” representing the pixels having pixel values of “0” are omitted, and only the signs “1” representing the pixels having pixel values of “1” are noted.

Hereinafter, contents of the sampling rate control table 161 stored in the storage section 16 will be described.

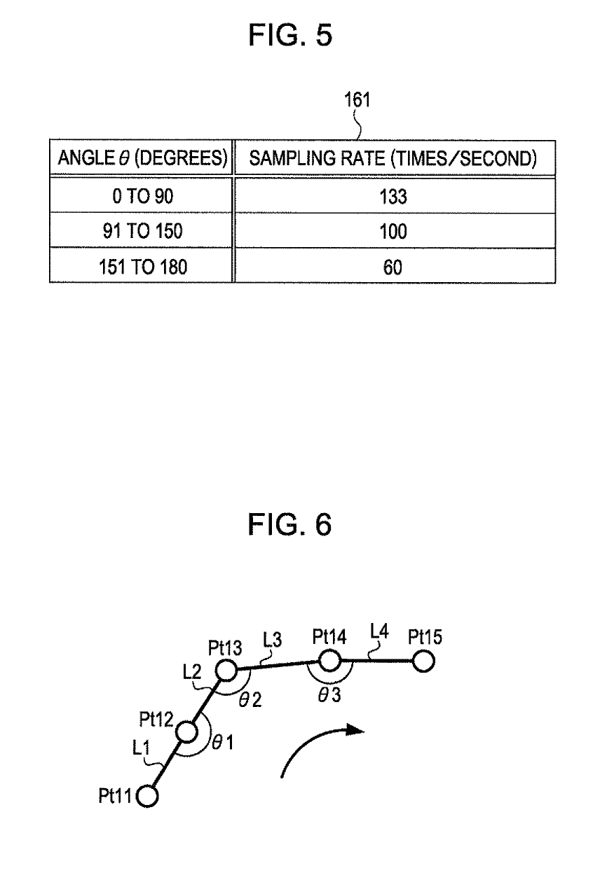

FIG. 5 is a diagram illustrating an example of the sampling rate control table 161. As shown in the drawing, in the sampling rate control table 161, the “angle θ” corresponds to the “sampling rate”. Specifically, in the sampling rate control table 161, the angle θ of “0 to 90 (degrees)” corresponds to the sampling rate of “60 (times/second)”, the angle θ of “91 to 150 (degrees)” corresponds to the sampling rate “100 (times/second)”, and the angle θ of “151 to 180 (degrees)” corresponds to the sampling rate “133 (times/second)”. Furthermore, the “times/second”, which is the unit of the sampling rate, is defined as the number of times of the detection, which is performed by the control section 11 on the positions designated on the touch panel 17, for one second. That is, the sampling rate is a value representing a cycle in which the control section 11 detects the positions by using the touch panel 17. As the sampling rate becomes higher, the cycle, in which the control section 11 detects the positions, becomes shorter. In contrast, the sampling rate becomes lower, the cycle, in which the control section 11 detects the positions, becomes longer.

FIG. 6 is a diagram illustrating the “angle θ” noted in the sampling rate control table 161 shown in FIG. 5. The points Pt11, Pt12, Pt13, Pt14, and Pt15 shown in the drawing represent the positions (points), which are detected by the control section 11, among the positions which are successively designated by a user and formed in a curve shape. Here, the segment that links the points Pt11 and Pt12 is denoted by L1, the segment that links the points Pt12 and Pt13 is denoted by L2, the segment that links the points Pt13 and Pt14 is denoted by L3, and the segment that links the points Pt14 and Pt15 is denoted by L4. A direction of each segment that links the two points successively detected is set as a direction of the trace. For example, a direction of the trace at the point Pt11 is a direction of the segment L1, and a direction of the trace at the point Pt12 is a direction of the segment L2. The “angle θ” represents an angle formed by two segments adjacent to each other, and herein is an acute angle. Furthermore, in the following description, each point referenced by the sign “Pt” represents the position detected on the touch panel 17 by the control section 11, positions are successively designated by the stylus pen 2 in a direction (the arrow direction) in which the value added to the end of the sign increases.

For example, as shown in FIG. 6, the segments L1 and L2 form an angle θ of θ1 equal to 180 degrees, the segments L2 and L3 form an angle θ of θ2 equal to 120 degrees, and the segments L3 and L4 form an angle θ of θ3 equal to 160 degrees. The segments L1 and L2 forming the angle θ of θ1 equal to 180 degrees are segments that respectively link the points Pt11 and Pt12 and the points Pt12 and Pt13, and thus the respective points are in the same straight line. That is, the positions designated by the stylus pen 2 are in the same straight line in this part. Next, the segments L2 and L3 forming the angle θ of θ2 equal to 120 degrees are segments that respectively link the points Pt12 and Pt13 and the points Pt13 and Pt14. This means that, as shown in the drawing, the direction in which the positions are designated changes at the point Pt13. Further, the segments L3 and L4 forming the angle θ of θ3 equal to 160 degrees are segments that respectively link the points Pt13 and Pt14 and the points Pt14 and Pt15. Hence, as shown in the drawing, the direction in which the positions are designated also changes at the point Pt14. However, θ2<θ3, and therefore the magnitude of change of the direction at the point Pt14 is smaller that that at the point Pt13.

That is, as the angle θ becomes closer to 180 degrees, the magnitude of change of the direction of the trace that sequentially links the positions becomes smaller. In contrast, as the angle θ becomes smaller than 180 degrees, the magnitude of change of the direction of the trace becomes larger. As described above, the angle θ is a value representing the magnitude of change of the direction of the trace, and the trace is designated in which the curvature thereof becomes larger as the magnitude of change becomes larger and the curvature thereof becomes smaller as the magnitude of change becomes smaller.

The control section 11 calculates the angle θ as the magnitude of change of the direction of the trace in the manner mentioned above. Then, the control section 11 determines the sampling rate on the basis of the angle θ as the magnitude of change of the trace and the correspondence relationship noted in the sampling rate control table 161.

Subsequently, the reason for changing the sampling rate will be described.

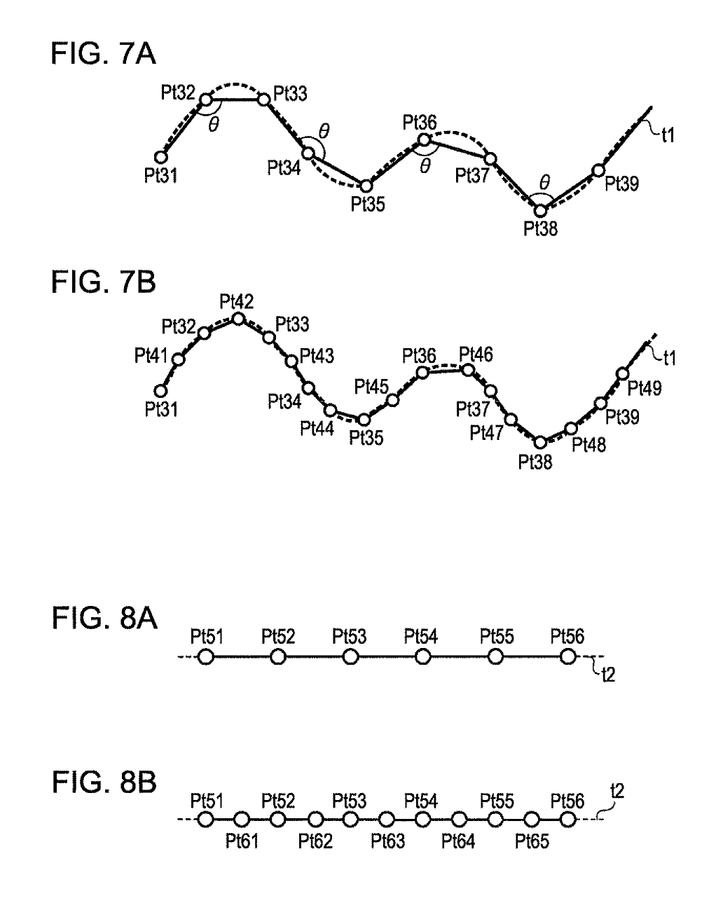

FIGS. 7A, 7B, 8A, and 8B are diagrams illustrating relationships between the positions on the touch panel 17 detected by the control section 11 and positions of an image representing a trace which is displayed on the display surface 141 when the positions are detected at two sampling rates different from each other. FIGS. 7A and 7B is a diagram showing exemplary cases where the positions t1 successively formed in a curve shape are designated. FIG. 7A shows the case of a low sampling rate. FIG. 7B shows the case of a high sampling rate. Specifically, the sampling rate shown in FIG. 7B is two times that shown in FIG. 7A. FIGS. 8A and 8B are diagrams showing exemplary cases where the positions t2 successively formed in a linear shape are designated. FIG. 8A shows the case of a low sampling rate. FIG. 8B shows the case of a high sampling rate. Specifically, the sampling rate shown in FIG. 8B is two times that shown in FIG. 8A. In FIGS. 7A, 7B, 8A, and 8B, the dashed lines indicate positions t1 and t2 actually designated by the operation of the stylus pen 2 of the user. The segments of the solid line linking the respective points indicate the positions of the image representing a trace displayed on the display surface 141.

First, as shown in FIG. 7A, focusing on change of the direction of the positions t1, the angles θ at points Pt32, Pt34, Pt36, and Pt38 are significantly smaller than 180 degrees, and thus the magnitude of change of the direction of the trace is large. In addition, in the positions subsequent to the respective points, positional deviation between the positions t1 and the image representing the trace becomes large. As described above, when the magnitude of change of the direction of the trace is large, positional deviation of the image displayed on the display surface 141 may increase relative to the actually designated positions.

On the other hand, as shown in FIG. 7B, when the position is detected at the sampling rate which is two times that of FIG. 7A, the point Pt42 is detected between the points Pt32 and Pt33 shown in FIG. 7A, the point Pt44 is detected between the point Pt34 and Pt35, the point Pt46 is detected between the point Pt36 and Pt37, and the point Pt48 is detected between the point Pt38 and Pt39. In this case, it can be observed that, even at the positions at which the positions t1 and the image representing the trace are deviated from each other in the example shown in FIG. 7A, both of those satisfactorily coincide with each other. As described above, in order to accurately display the image representing the trace, it is more preferable to employ a higher sampling rate. However, when the sampling rate is set to be high, the control section 11 more frequently detects the positions by using the touch panel 17. As a result, power consumption of the apparatus increases by the extent that the detection and the display of the image are performed.

Subsequently, as shown in FIGS. 8A and 8B, when the designated positions t2 are formed in a linear shape, the image representing the trace is accurately displayed even when the position detection is performed at any of the sampling rates. As described above, when the designated positions are formed in a linear shape or a curve shape (a substantially linear shape) having a small curvature, the trace image is accurately displayed regardless of the magnitude of the sampling rate. In other words, when the positions successively formed in the linear shape or the substantially linear shape are designated by the stylus pen 2, although the sampling rate is low at the time of position detection performed by the control section 11, this has no negative effect on the display of the trace image. The reason is that, as described in FIG. 4, the control section 11 displays the image representing the trace on the display surface 141 by sequentially linking the positions, which are detected by the touch panel 17, to each other.

### B. Operation

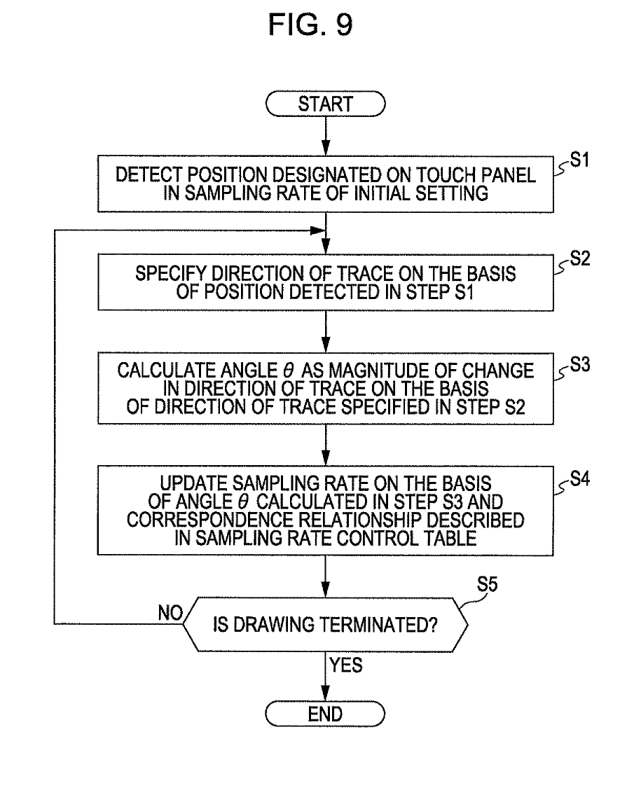

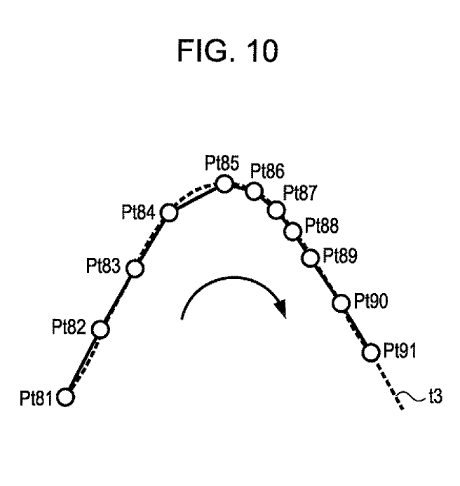

Subsequently, operations of the display apparatus 10 will be described in detail with reference to FIGS. 9 and 10.

FIG. 9 is a flowchart illustrating an operation procedure of a control relating to a change of a sampling rate executed by the control section 11. FIG. 10 is a diagram illustrating a positional relationship between positions t3 successively designated on the touch panel 17 and the image representing the trace of the positions t3 which are displayed on the display surface 141. Furthermore, in the drawing, the positions are designated by the stylus pen 2 along the arrow.

When the positions are designated by the stylus pen 2, first the control section 11 detects the positions at a sampling rate (for example, 100 times/second) of an initial setting (step S1). Then, the control section 11 acquires coordinates corresponding to the positions detected in step S1 from the memory, and specifies the direction of the trace on the basis of the acquired coordinates in the manner mentioned above (step S2). For example, when detecting the points Pt81 and Pt82 shown in FIG. 10 in this order, the control section 11 specifies the direction of the segment that links the two points as the direction of the trace at the point Pt81. Consequently, the control section 11 is an example of the direction specifying section.

Next, the control section 11 calculates the angle θ as the magnitude of change of the direction of the trace on the basis of the direction of the trace specified in step S2 (step S3). Here, the control section 11 calculates the angle θ on the basis of the coordinates corresponding to three positions successively detected. The control section 11 detects the three points Pt81, Pt82, and Pt83, and then calculates the angle θ as the magnitude of directional change at the point Pt82 as described in FIG. 6.

Next, the control section 11 renews the sampling rate on the basis of the angle θ calculated in step S3 and the correspondence relationship noted in the sampling rate control table 161 (step S4). Here, when the angle θ of θ1 at the point Pt82 calculated in step S3 is equal to 180 degrees, the control section 11 decreases the sampling rate from “100 times/second” to “60 times/second”.

Then, the control section 11 determines whether or not the drawing using the stylus pen 2 is terminated (step S5). Here, the termination of the drawing includes, for example, the cases where the display apparatus 10 terminates the operation in a mode of performing the drawing using the stylus pen 2 and the designation of the successive positions is terminated once by making the stylus pen 2 apart from the touch panel 17.

In the midst of the designation of the successive positions, if the control section 11 determines “NO” in step S5, the flow returns to step S2. Then, the control section 11 specifies the direction of the trace at the subsequently detected point Pt84, and then calculates the angle θ as the magnitude of change of the direction of the trace at the point Pt83 (step S2, S3). If it is determined that the angle θ at the point Pt84 is in the range of “151 to 180 degrees” in step S3, the control section 11 keeps the sampling rate at “60 times/second” in step S4 (step S4).

Then, the control section 11 detects the point Pt85, and calculates the angle θ of 120 degrees at the point Pt84 (steps S2 and S3). In this case, the control section 11 increases the sampling rate from “60 times/second” to “100 times/second” (step S4). The angle θ of 120 degrees means that a user designates the positions formed in a curve shape having a large curvature and thus the magnitude of change of the direction of the trace increases. In accordance with the increase, the control section 11 increases the sampling rate so as to accurately display the image representing the trace formed in a curve shape having a large curvature. Thereafter, since the magnitude of change of the direction of the trace is nearly zero when the positions of the points Pt86 and Pt87 are detected, the control section 11 keeps the sampling rate at “100 times/second”.

Subsequently, the control section 11 detects the position of the point Pt89, and calculates the angle θ of 180 degrees at the point Pt88 (steps S2 and S3). In this case, the control section 11 decreases the sampling rate from “100 times/second” to “60 times/second” (step S4). The angle θ of 180 degrees means that a user designates the positions formed in a linear shape and thus the magnitude of change of the direction of the trace decreases. In accordance with the decrease, the control section 11 decreases the sampling rate so as to reduce power consumption required for the drawing. The reason is that the trace formed in a linear shape or a substantially linear shape is designated and thus it is possible to accurately display the image representing the trace even when the sampling rate is low.

Then, the control section 11 detects the designated positions of the points Pt90 and Pt91 formed in a linear shape or a substantially linear shape. In this case, the control section 11 keeps the sampling rate at “60 times/second”.

The control section 11 repeats the process steps until the drawing is terminated, and if “YES” is determined in step S5, at this point, the control section 11 terminates the control relating to the change of the sampling rate.

Thereafter, when a user restarts the designation of the positions, the control section 11 detects the positions at the sampling rate of the initial setting, and changes the sampling rate by performing the same process steps S1 to S5. As described above, the control section 11 and the display controller 13 are examples of the cycle changing section, In a case where the direction of the trace of the specific positions changes, when the magnitude of change of the direction increases, the cycle changing section shortens a cycle for detecting the positions. In contrast, when the magnitude of change of the trace corresponding to the specific positions decreases, the cycle changing section elongates the cycle for detecting the positions.

In the above-mentioned embodiment, the control section 11 of the display apparatus 10 detects the positions, which are successively designated by a user, at a determined sampling rate, and displays the image representing the trace, which sequentially links the detected positions, on the display surface 141. At this time, the control section 11 calculates each angle θ for each direction of the trace. Then, the control section 11 detects the positions by decreasing the sampling rate when the calculated angle θ is sufficiently smaller than 180 degrees and the magnitude of change of the direction of the trace decreases. With such a configuration, when the positions formed in a linear shape or a substantially linear shape having a small curvature are designated, the control section 11 is able to accurately display the image representing the trace, and to reduce power consumption required to display. In contrast, when the positions formed in a curve shape having a large curvature are designated, the control section 11 is able to accurately display the image by increasing the sampling rate. Since a battery is used in the power supply section 12 as described above, it is required to reduce power consumption in the entire apparatus. However, with the configuration of the embodiment, it is possible to reduce power consumption required for the drawing without deterioration in quality of the image representing the trace.

### C. Modified Examples

Furthermore, the embodiment may be modified as follows. Specifically, for example, the following modifications are exemplified. In such modifications, the respective elements may be appropriately combined.

### C-1. Modified Example 1

In the above-mentioned embodiment, the control section 11 calculates the angle θ as the magnitude of change of the direction of the trace. However, the magnitude of change may be calculated in another method. As described above, the control section 11 calculates the angle θ on the basis of coordinates of the three points. However, in the orthogonal coordinate system, the direction of the trace is easily specified on the basis of the positional relationship among the coordinates. Accordingly, the control section 11 may not calculate every angle θ, but instead may instantly calculate the magnitude of change of the direction of the trace from the positional relationship of the coordinates. Further, the angle by which the direction of the positions successively designated by the stylus pen 2 changes may be set as the magnitude of change. In this case, the control section 11 may calculate an angle of deviation between a direction of a trace obtained at certain positions and a direction of the trace of the positions subsequently detected, and may set the angle as the magnitude of change of the direction of the trace. In short, the magnitude of change of the direction of the trace has only to be a value representing a degree of the directional change.

In the above-mentioned embodiment, the control section 11 selects any one of the three sampling rates. However, the control section 11 may be modified to be able to select a lot of sampling rates additionally provided. In addition, instead of the sampling rate, the cycle itself as time information may be employed. Further, the sampling rate control table 161 is noted as a table form in which the angle θ corresponds to the sampling rate. However, the correspondence relationship thereof may be defined as another form such as a mathematical function.

### C-2. Modified Example 2

In the above-mentioned embodiment, the control section 11 allows a user to designate successive positions, and calculates the magnitude of change of the trace direction whenever detecting the position. However, the control section may calculate the magnitude of change of the direction of the trace for each cycle longer than the position detection cycle for displaying the trace image on the display surface 141.

Further, the control section 11 may change the sampling rate on the basis of a frequency exceeding a threshold value of the magnitude of change of the trace direction. For example, the positions formed in a curve shape, which has a large curvature by the number of times per unit time equal to or more than the threshold value, may be designated. In this case, it seems very possible that the positions formed in a curve shape having a large curvature are also designated thereafter. Accordingly, if the control section 11 determines that the frequency of an increase in the magnitude of change of the trace direction exceeds the threshold value, the control section 11 may perform the position detection with a high sampling rate maintained until it is determined in step S5 that the drawing is terminated. In the same manner, if the frequency of a decrease in the magnitude of change of the trace direction exceeds the threshold value, the control section 11 may lower the sampling rate until the drawing is terminated.

### C-3. Modified Example 3

In the above-mentioned embodiment, the control section 11 may correct the sampling rate, which is calculated on the basis of the magnitude of change of the direction of the trace, in accordance with a rate (hereinafter, it is referred to as a “designation rate”) of the trace successively designated by the stylus pen 2. Here, the designation rate is a value obtained by dividing the distance between two positions, which are successively detected on the touch panel 17 by the control section 11, by a cycle at the time of the position detection, and corresponds to a displacement of the pen tip of the stylus pen 2 per unit time. Consequently, the control section 11 is an example of the rate specifying section.

When the control section 11 performs the position detection at a certain constant sampling rate, the distance between the detected positions becomes larger as the designation rate becomes higher. The display apparatus 10 displays the image on the display surface 141 by sequentially linking the detected positions. Hence, as the designation rate increases, the distances between the positions increase, and thus the accuracy of the trace image relative to the designated positions tends to become lower. In particular, the positions may be formed in a curve shape having a large magnitude of change of the direction of the trace. In such a case, when the positions are designated at a high designation rate, the accuracy of the image representing the trace may be remarkably lost.

In such a case, the control section 11 performs correction so as to increase the sampling rate, which is calculated on the basis of the magnitude of change of the direction of the trace, by a correction amount based on the designation rate. For example, when the designation rate is high, the control section 11 performs the correction so as to increase a specific sampling rate from “133 (times/second)” to “150 (times/second)” on the basis of the change of the direction of the trace and the sampling rate control table 161. In contrast, when the designation rate is low, the distances between the detected positions decrease even when the sampling rate is low. Hence, the accuracy of the image representing the designated positions hardly deteriorates. Accordingly, the control section 11 performs the correction so as to decrease the specific sampling rate from “133 (times/second)” to “110 (times/second)” on the basis of the magnitude of the change of the direction of the trace and the sampling rate control table 161. Such a control section 11 is an example of the correction section, corrects the cycle which changes in accordance with the magnitude of change of the direction of the trace, on the basis of a specific rate of the trace. Furthermore, correspondence relationships among the designation rate, the correction amount, and the correction amount of the sampling rate may be stored in a preliminary memory and the storage section 16. With such a configuration, it is possible to more accurately display the image representing the trace and further suppress power consumption required for the drawing.

### C-4. Modified Example 4

In the above-mentioned embodiment, the display apparatus 10 increases the sampling rate when the magnitude of change of the specific trace direction increases, and decrease the sampling rate when the magnitude of change of the trace direction decreases. In contrast, the display apparatus 10 may perform only any one of those. For example, the control section 11 increases the sampling rate from an initial setting value when the magnitude of change of the direction of the specific trace increases, and returns the increased sampling rate to the initial setting value when a predetermined time elapses. In the same manner, the control section 11 decreases the sampling rate from the initial setting value when the magnitude of change of the direction of the specific trace decreases, and returns the decreased sampling rate to the initial setting value when a predetermined time elapses.

### C-5. Modified Example 5

In the above-mentioned embodiment, the storable display body 14 is a display body having a liquid crystal layer using storable liquid crystal. However, a display body, of which the display regions are formed of display elements using another driving method, may be used. For example, an electrophoresis type display body or an electrochromic type display body may be used. Further, the display apparatus 10 may display a single color image, and may display a multi-color image.

### C-6. Modified Example 6

In the above-mentioned embodiment, the display apparatus 10 is a thin and portable display apparatus which is called an electronic paper. However, any display apparatus may be used if only it is able to perform the information process as described in the embodiment, and a display apparatus such as a PDA or mobile phone may be used.

### C-7. Modified Example 7

In the above-mentioned embodiment, the stylus pen 2 is used when a user designates positions, but it is apparent that a finger of the user may be used for the designation. Further, the stylus pen may have the function of detecting the successively designated positions. In this case, coordinates of the positions are notified from the stylus pen to the display apparatus main body by using a wireless signal and the like, and the main body may calculate the magnitude of change of the direction of the trace and may change the sampling rate in accordance therewith.

Further, instead of the touch panel 17 disposed on the display surface 141, a pen tablet may be used. That is, when a user designates the trace on a planar tablet by using a pen type input device or a mouse, the apparatus displays the trace image on the display surface by reading the position coordinates representing the positions and moving a pointer on the display.

### C-8. Modified Example 8

In the above-mentioned embodiment, the whole control is performed by the control section 11, but a part of the control may be performed in cooperation with other hardware, and may be performed by one or a plurality of hardware other than that. Further, when the control section 11 executes a program to perform various controls, the program may be embodied by combination of a plurality of programs. In addition, the program can be provided in a state where it is recorded in a computer-readable recording medium such as a magnetic recording medium (a magnetic tape, a magnetic disk, or the like), an optical recording medium (an optical disk such as a CD or a DVD, or the like), a magnetic optical recording medium, or a semiconductor memory. Further, the program may be downloaded via a communication network such as an Internet.

What is claimed is:

1. A display apparatus comprising:
a display surface that includes a plurality of pixels;
a detection section that detects positions of the plurality of pixels successively designated on the display surface for each predetermined cycle;
a rewriting section that rewrites colors of the pixels corresponding to the trace sequentially linking the positions detected by the detection section;
a direction specifying section that, when the detection section detects the positions, specifies the direction of the trace at the corresponding positions; and
a cycle changing section that, when the direction of the trace specified by the direction specifying section is changed and the magnitude of change of the corresponding direction increases, shortens the cycle in which the detection section detects the positions.

2. A display apparatus comprising:
a display surface that includes a plurality of pixels;
a detection section that detects positions of the plurality of pixels successively designated on the display surface for each predetermined cycle;
a rewriting section that rewrites colors of the pixels corresponding to the trace sequentially linking the positions detected by the detection section;
a direction specifying section that, when the detection section detects the positions, specifies a direction of the trace at the corresponding positions; and
a cycle changing section that, when the direction of the trace specified by the direction specifying section is changed and a magnitude of change of the corresponding direction decreases, elongates the cycle in which the detection section detects the positions.

3. The display apparatus according to claim 1,
wherein the direction specifying section sequentially specifies a direction of a segment linking two positions, which are successively detected by the detection section, as the direction of the trace, and
wherein the magnitude of change of the direction is an angle formed by the two segments sequentially specified as the direction of the trace by the direction specifying section.

4. The display apparatus according to claim 1, further comprising:
a rate specifying section that specifies a value as a rate at the time of successively designating the positions of the plurality of pixels, the value being obtained by dividing the distance between the two positions, which are successively detected by the detection section, by the predetermined cycle,
wherein the cycle changing section includes a correction section that corrects the cycle, which changes in accordance with the magnitude of the change, on the basis of the rate specified by the rate specifying section.

5. A program for causing a computer, which controls a display apparatus having a display surface formed of a plurality of pixels, to function as:
a detection section that detects positions of the plurality of pixels successively designated on the display surface for each predetermined cycle;
a rewriting section that rewrites colors of the pixels corresponding to the trace sequentially linking the positions detected by the detection section;
a direction specifying section that, when the detection section detects the positions, specifies a direction of the trace at the corresponding positions; and
a cycle changing section that, when the direction of the trace specified by the direction specifying section is changed and a magnitude of change of the corresponding direction increases, shortens the cycle in which the detection section detects the positions.

6. A program for causing a computer, which controls a display apparatus having a display surface formed of a plurality of pixels, to function as:
a detection section that detects positions of the plurality of pixels successively designated on the display surface for each predetermined cycle;
a rewriting section that rewrites colors of the pixels corresponding to the trace sequentially linking the positions detected by the detection section;
a direction specifying section that, when the detection section detects the positions, specifies a direction of the trace at the corresponding positions; and
a cycle changing section that, when the direction of the trace specified by the direction specifying section is changed and a magnitude of change of the corresponding direction decreases, elongates the cycle in which the detection section detects the positions.
